(19) United States
(12) Patent Application Publication
(10) Pub. No.: US 2016/0305898 A1
(43) Pub. Date: Oct. 20, 2016

(54) ARRANGEMENT AND METHOD FOR MEASURING AND CONTROLLING THE HEATING TEMPERATURE IN A SEMICONDUCTOR GAS SENSOR

(71) Applicant: ZENTRUM MIKROELEKTRONIK DRESDEN AG, Dresden (DE)

(72) Inventors: Michael GEORGI, Freital (DE); Ronald SCHREIBER, Freital (DE)

(21) Appl. No.: 15/099,744

(22) Filed: Apr. 15, 2016

(30) Foreign Application Priority Data
Apr. 17, 2015 (DE) 10 2015 105 871.5

(51) Int. Cl. G01N 27/12

(52) U.S. Cl. CPC G01N 27/125

(57) ABSTRACT

An arrangement is provided for controlling the heating temperature in a semiconductor gas sensor comprising a control loop, consisting of a heating resistor as automatic control system of a measurement device measuring a physical quantity representing the temperature of the heating resistor, and an actuating unit controlling a power supply of the heating resistor, and a method which utilizes the arrangement. The actuating unit includes a pulsating voltage source, having a first pulse duration, during which the heating resistor is connected to an operating voltage, and a second pulse duration, during which the heating resistor is separated from the operating voltage, whose first and/or second pulse duration can be controlled as a correcting variable, A constant current source applies a measuring current to the heating resistor during the second pulse duration and a measurement device measures the measurement voltage drop across the heating resistor, whose output is designed as a controlled variable feedback in the control loop.

### CROSS REFERENCE TO RELATED APPLICATIONS

This application claims priority of German Application No. 10 2015 105 871.5 filed on Apr. 17, 2015, the entire contents of which is hereby incorporated by reference herein.

### BACKGROUND ART

The invention concerns an arrangement for controlling the heating temperature in a semiconductor gas sensor comprising a control loop, consisting of a heating resistor as automatic control system of a measurement device measuring a physical quantity representing the temperature of the heating resistor, and an actuating unit controlling a power supply of the heating resistor.

The invention also concerns a method for measuring and controlling the heating temperature of a heating resistor in a semiconductor gas sensor.

Semiconductor gas sensors, also known as metal oxide (MOX for short) semiconductor gas sensors, are electrical conductivity sensors. They consist of a sensor resistor, which needs to be heated to a working temperature. The resistance of its sensory-active layer changes upon contact with the gas being detected. The gas enters into an ideally fully reversible reaction with the sensor surface. Due to their chemical nature, metal oxide gas sensors are suitable for a broad area of application and the detection of all reactive gases. Depending on the materials used and the gases being detected, operating temperatures between 300° C. and 900° C. are customary.

The areas of use of semiconductor gas sensors are very diverse and extend from safety technology (explosions, leakage, fire and intoxication protection) to emission and air quality monitoring to quality assurance and process metering technology. The measurement range depends on the gas being detected and extends from a few ppb to percentages. The limit of detection is dependent on the gas-sensitive material. The operating temperatures are likewise dependent on the material of the sensitive layer and the optimal response behavior of the sensors.

The working temperature to which the sensor resistor needs to be heated also has influence on the sensitivity and selectivity of the sensor resistor and must therefore be adjusted as accurately as possible. A good selectivity for a gas sensor means that its sensor reaction is directed at a target substance, such as a gas being detected, and only this substance is detected. Usually the heating is done by a heating resistor, which is thermally well coupled to the sensor resistor. For the measuring of the working temperature, one uses either a separate temperature sensor or one utilizes the temperature dependency of the heating resistor. For example, the heating resistor can be made of platinum and then it has a precisely defined temperature dependence. In the present invention, no separate temperature sensor is used, but instead the heating resistor is used both for the heating and for the measuring of the working temperature.

The temperature of the heating resistor can be controlled via the electric power of the resistor. There are various methods known for this:

One can use an actuating element to adjust the voltage across or the current flowing through the heating resistor. In this case, a power loss arises across the analog actuating element, which detracts from the electrical efficiency of the arrangement. A sample arrangement is shown in FIG. 1. As the analog actuating element, one uses a transistor or a potentiometer, for example. A shunt resistor 116 with a very low resistance value serves as the current measurement 115. At the same time, the measurement signal for the heating current and the heating voltage 114 is picked off.

Another method consists in using a digital actuating element to switch the voltage across or the current through the heating resistor on and off, so that the desired mean power results from the on and off time. The switching on and off can occur in the form of a pulse width or pulse density modulation. Ideally, the actuating element thanks to the digital operation has no power loss of its own and a very high electrical efficiency can be achieved.

For the heating, a voltage must be applied to the heating resistor and a current must flow. The resulting electrical power is transformed into heat in the heating resistor and results in the heating of the heating resistor, which heats the sensor resistor. In order to control the electric power (and thus the temperature of the heating resistor and the sensor resistor), either the voltage across the heating resistor or the current through the heating resistor has to be controlled.

For the measurement of the temperature, the resistance value of the heating resistor has to be measured, since the resistance value is a measure of the temperature of the sensor resistor. But for this, the voltage across the heating resistor and the current through the heating resistor has to be known or measured.

Known actuating circuits which enable the heating and temperature measuring are very complex, however, and have only a low electrical efficiency. The circuit shown for example in FIG. 1 is very simple in layout, but it has a poor efficiency on account of the high power loss of the analog actuating element and the shunt resistor. A digital actuating element, while not having its own power loss, would make the measurement of the heating resistance very complicated: on the one hand, one would have to measure the current through the heating element during the on time, such as by means of a shunt resistor, but this would once more detract from the power efficiency. On the other hand, the voltage across the heating resistor during the on time would have to be known. This would be the result of the (unknown) operating voltage minus the (unknown) voltage drop across the digital actuating element minus the voltage drop across the shunt resistor.

Therefore, the problem which the invention proposes to solve is to indicate an actuating circuit for a heating resistor in a semiconductor gas sensor which eliminates the previous drawbacks of the prior art and enables a simple control of the electric power of the heating resistor, can measure the resistance value of the heating resistor, and has a high electrical efficiency. A circuit with a low power loss is especially important precisely for mobile use.

At the same time, the temperature of the heating resistor and thus the temperature of the sensor resistor of the semiconductor gas sensor should be exactly adaptable to the measurement requirements. This temperature adaptation should also be exactly adaptable when the operating voltage VDD of the arrangement is subject to unpredictable fluctuations. Therefore, a decoupling of the operating voltage VDD from the measurement process is especially important.

### BRIEF SUMMARY OF THE INVENTION

The problem of the invention is solved, in terms of the arrangement, in that the actuating unit consists of a pulsating voltage source, having a first pulse duration, during which the heating resistor is connected to an operating voltage VDD, and a second pulse duration, during which the heating resistor is separated from the operating voltage VDD, whose first and/or second pulse duration can be controlled as a correcting variable, and there is provided a constant current source applying a measuring current to the heating resistor during the second pulse duration and a measurement device measuring the measurement voltage drop across the heating resistor, whose output is designed as a controlled variable feedback in the control loop. The actuating unit serves to connect the heating resistor during a first pulse duration (on time of the actuating unit) to the power supply, i.e., a voltage is applied and a current flows through the heating resistor, which is thereby warmed, i.e., heated. The voltage VDD is not constant, but rather is subject to fluctuations, which must be taken into account in the heating of the heating resistor. During the second pulse duration (off time of the actuating unit), the heating resistor is separated from the power supply and is not connected to a constant current source, which sends a known measurement current through the heating resistor, during which time the measurement device measures the voltage drop across the heating resistor generated by the measurement current. The voltage drop produced by the measurement current during the off time is a measure of the resistance value of the heating resistor and thus a measure of the temperature of the sensor resistor. In this way, the measurement of the heating resistor is decoupled from the rest of the layout and no longer subject to the fluctuating voltage VDD of the power supply. The measurement device is designed as a voltage measuring circuit and can generate from the measurement signal a signal which corresponds to the temperature of the heating resistor and thus the temperature of the sensor resistor. This signal constitutes the controlled variable in the control loop formed by actuating unit and measurement device, so that in this way the temperature of the sensor resistor can be exactly adjusted by the actuation of the actuating unit. By applying a constant measurement current, one only needs to measure the voltage across the heating resistor to determine the power through the heating resistor. Thanks to this layout, that can be done with a high electrical efficiency, since almost no losses occur in this switching and measuring layout, because in the first place the analog actuating element formerly used in such measurement layouts has been eliminated, being the largest source of losses, and consuming around 70% of the total power, and in the second place no shunt resistor is used, which would generate around 10% power loss depending on its dimensioning. While the source of measurement current also generates a power loss, the measurement current can be kept low, in order to minimize the power loss.

In one advantageous embodiment, the actuating unit is designed as digitally switchable. That is, a switch such as a MOSFET is switched on and off by a PWM signal, for example.

Furthermore, a differential amplifier is configured in the control loop for determining a control deviation between the controlled variable feedback and a controlling variable. Moreover, a generator and a comparator are configured to generate the correcting variable. The temperature signal, which is generated from the measurement signal of the measurement device, is subtracted from a nominal value setpoint for the desired temperature and amplified in an error amplifier. The amplified deviation is compared in a comparator with a modulation signal, such as a triangular or sawtooth signal, which is produced in a generator. The result of the comparison is the correcting variable for the control of the actuating element and the measurement device. The correcting variable can be, e.g., a pulse width modulated (PWM) signal.

In terms of the method, the problem of the invention is solved in that the heating resistor is supplied with a pulsed voltage with a first pulse duration of an on state and a second pulse duration of an off state, wherein the first and/or the second pulse duration constitute the correcting variable of the control loop and the heating resistor receives a measurement current of a constant voltage source during the second pulse duration, wherein a voltage generated by the measurement current across the heating resistor is measured and used as a controlled variable. It is especially advantageous that the measurement of the voltage is done independently and separately from the power supply voltage VDD. In this way, the measurement result is not influenced by an inconstant, i.e., fluctuating power supply voltage. By a fluctuating power supply voltage VDD is meant a voltage whose d.c. voltage value is not constant over time, but instead varies according to the application. For example, in applications which are direct battery operations, the battery voltage is dependent on the charge condition. Load fluctuations can also occur, such as voltage fluctuations in a mobile telephone when the transmitter is switched on or off. The present invention furthermore offers the ability to cover a broad operating voltage range, such as 2.6 V to 3.6 V. During a first pulse duration (on time of the actuating unit) the heating resistor is connected to a power supply, i.e., a voltage is applied and a current flows through the heating resistor, whereupon the heating resistor is warmed by this, i.e., heated. During a second pulse duration (off time of the actuating unit) the heating resistor is separated from the power supply and is now connected to a current source, so that a known measurement current flows through the heating resistor, whereupon at the same time the voltage drop across the heating resistor generated by the measurement current is measured by means of the measurement device. At the same time means that the measurement circuit is activated or deactivated depending on the control signal for the actuating unit. During the on time, the measurement circuit is deactivated, and during the off time the measurement circuit is activated and measures the voltage across the heating resistor. The voltage drop produced by the measurement current during the off time is a measure of the resistance value of the heating resistor and thus a measure of the temperature of the sensor resistor. The voltage measuring circuit can thus generate a signal which corresponds to the temperature of the heating resistor and thus the temperature of the sensor resistor, wherein the measurement is done decoupled from the inconstant power supply voltage of the arrangement for control of the heating resistor. This signal constitutes the controlled variable in the control loop formed by actuating element and measurement device, so that in this way the temperature of the sensor resistor can be adjusted exactly by the actuation of the actuating unit.

It is important for the proposed method that the temperature of the heating resistor is measured regularly, in order to counteract temperature deviations. For this, there is a periodic switching between the first and the second switching state by means of the actuating mechanism. The actuating unit ensures that in an on time of the actuating unit the heating resistor is connected to the power supply, i.e., a voltage is applied to the heating resistor, which warms the heating, and in an off time of the actuating unit the heating resistor is connected to the current source, so that the temperature of the heating resistor can be measured.

The voltage across the heating resistor measured by the measurement current is a measure of a heating temperature of the heating resistor and serves as a controlled variable in the method according to the invention, while the controlled variable is subtracted from a setpoint setting and a deviation is amplified in an amplifier. The setpoint setting depends on the kind of semiconductor gas sensor and its area of use. Depending on which sensor resistor material is used and which gas is to be detected, an exact temperature of the sensor resistor can be adjusted via the heating resistor. By the control system, a tracking of the sensor temperature is possible with no problem.

The deviation of the heating temperature and the setpoint setting for the temperature is compared with a modulation signal by means of a comparator, and the correcting variable for control of the actuating unit and the measurement circuit is generated from the result of the comparison. For example, the correcting variable can be a PWM signal. A duration of the first switching state and a duration of the second switching state form a timing ratio m, and a heat generated in the heating resistor is adjusted in terms of the timing ratio m. The timing ratio, i.e., the fraction of the on time compared to the total time of this pulse width modulated signal, for example, determines the heat produced in the heating resistor.

The invention shall now be explained more closely by means of sample embodiments.

### BRIEF DESCRIPTION OF THE DRAWING FIGURES

The accompanying drawings show

FIG. 1 An actuating circuit for the heating resistor in a semiconductor gas sensor for the measurement of the temperature of the heating resistor according to the prior art;

FIG. 2 a driver circuit according to the invention for heating resistors in a semiconductor gas sensor;

FIG. 3 schematic of a classical control loop;

FIG. 4 a driver and measurement circuit according to the invention for heating resistors in a semiconductor gas sensor as an automatic control system in a control loop.

### DETAILED DESCRIPTION

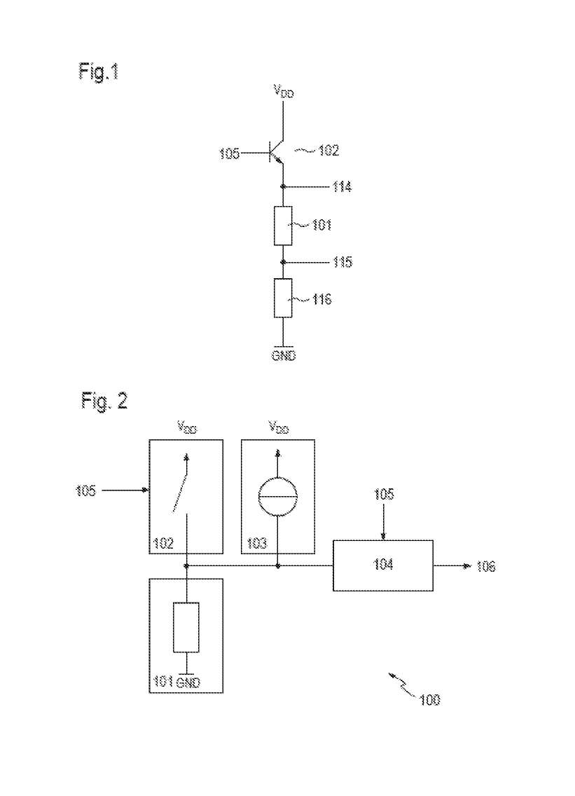

FIG. 2 shows the driver and measurement circuit 100 according to the invention. The actuating mechanism 102, such as a transistor acting as a switch, serves to connect the heating resistor 101 during a first pulse duration (on time of the actuating unit) to the power supply, i.e., a voltage is applied and a current flows through the heating resistor 101, which is warmed in this way, i.e., heated. During a second pulse duration (off time of the actuating unit) the heating resistor 101 is separated from the power source and bridged by the connection to a constant current source 103, whereupon the constant current source 103 sends a known measurement current through the heating resistor 101, and during this time the voltage drop across the heating resistor 101 generated by the measurement current by means of the measurement device 104 is measured. The voltage drop produced by the measurement current during the off time is a measure of the resistance value of the heating resistor 101 and thus a measure of the temperature of the sensor resistor. The voltage measuring circuit 104 can thus generate a signal 106 which corresponds to the temperature of the heating resistor 101 and thus the temperature of the sensor resistor. This signal 106 constitutes the controlled variable in the control loop 200, formed by the actuating element 102, the measurement device 104 and the automatic controller, which is formed by the generator 111 and the comparator 112, so that the temperature of the sensor resistor can be exactly adjusted in this way by the actuation of the actuating element 102.

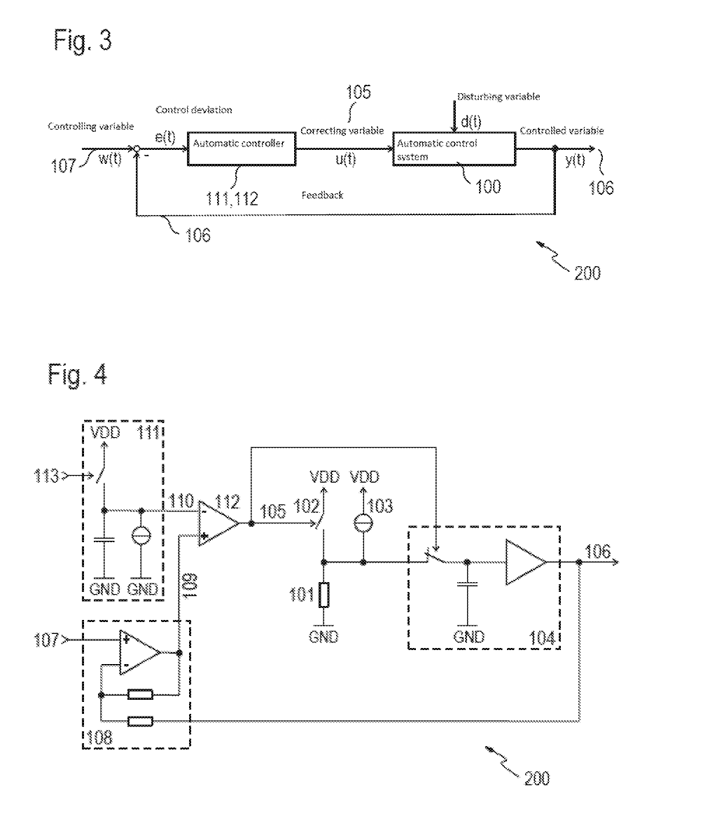

FIG. 3 shows a schematic of a classical control loop, in particular for the illustration and the matching up of the automatic control terminology used.

FIG. 4 shows schematically the arrangement according to the invention for the control of the heating temperature in a semiconductor gas sensor. The driver and measurement circuit corresponds exactly to the one shown in FIG. 2. The temperature signal 106, which is generated from the measurement signal of the measurement device, is subtracted from a setpoint setting 107 for the desired temperature and amplified in an error amplifier 108. The amplified deviation 109 is compared in a comparator 112 with a modulation signal 110, such as a triangular or sawtooth signal, which is produced in a generator 111. The result of the comparison is the pulse width modulated (PWM) signal 105 for control of the actuating element 102 and the measurement device 104.

1. An arrangement for controlling a heating temperature in a semiconductor gas sensor comprising a control loop, including a heating resistor as an automatic control system of a measurement device measuring a physical quantity representing temperature of the heating resistor, and an actuating unit controlling a power supply of the heating resistor, wherein the actuating unit comprises a pulsating voltage source, having a first pulse duration, during which the heating resistor is connected to an operating voltage VDD, and a second pulse duration, during which the heating resistor is separated from the operating voltage VDD, whose first and/or second pulse duration can be controlled as a correcting variable , and further comprising a constant current source applying a measuring current to the heating resistor during the second pulse duration and a measurement device measuring a measurement voltage drop across the heating resistor due to the measurement current, whose output comprises a controlled variable feedback in the control loop.

2. The arrangement for controlling the heating temperature in a semiconductor gas sensor according to claim 1, wherein the actuating unit is digitally switchable.

3. The arrangement for controlling the heating temperature in a semiconductor gas sensor according to claim 1, wherein a differential amplifier is configured in the control loop for determining a control deviation between the controlled variable feedback and a controlling variable, and a generator and a comparator generate the correcting variable.

4. A method for measuring and controlling a heating temperature of a heating resistor in a semiconductor gas sensor, utilizing the arrangement according to claim 1, wherein a physical quantity representing the temperature of the heating resistor constitutes the controlled variable of the control loop, wherein the heating resistor is supplied with a pulsed voltage with a first pulse duration of an on state and a second pulse duration of an off state, wherein the first and/or the second pulse duration constitute the correcting variable of the control loop and the heating resistor receives a measurement current of a constant voltage source during the second pulse duration, wherein a voltage generated by the measurement current across the heating resistor is measured and used as a controlled variable.

5. The method for measuring and controlling the heating temperature of a heating resistor in a semiconductor gas sensor according to claim 4, wherein there is a periodic switching between the first and the second switching state by means of an actuating element.

6. The method for measuring and controlling the heating temperature of a heating resistor in a semiconductor gas sensor according to claim 5, wherein the voltage across the heating resistor generated by the measurement current is subtracted from a setpoint setting and a deviation is amplified in an amplifier.

7. The method for measuring and controlling the heating temperature of a heating resistor in a semiconductor gas sensor according to claim 6, wherein the deviation of the heating temperature and the setpoint setting is compared with a modulation signal by a comparator, and the correcting variable for control of the actuating unit and the measurement circuit is generated from the result of the comparison.

8. The method for measuring and controlling the heating temperature of a heating resistor in a semiconductor gas sensor according to claim 7, wherein the correcting variable comprises a PWM signal.

9. The method for measuring and controlling the heating temperature of a heating resistor in a semiconductor gas sensor according to claim 6, wherein a duration of the first switching state and a duration of the second switching state form a timing ratio m, and a heat generated in the heating resistor is adjusted in terms of the timing ratio m.
